(19) United States
(12) Patent Application Publication
(10) Pub. No.: US 2026/0323421 A1
(43) Pub. Date: Oct. 15, 2026

(54) METHODS AND APPARATUS FOR PERFORMING LOWER LAYER TRIGGERED MOBILITY IN A WIRELESS COMMUNICATION SYSTEM

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/124,051

(22) PCT Filed: Jan. 3, 2024
(86) PCT No.: PCT/KR2024/000130

§ 371 Date: Apr. 24, 2025

(30) Foreign Application Priority Data
Jan. 7, 2023 (IN) 202341001431
Dec. 18, 2023 (IN) 2023 41001431

(51) Int. Cl. H04W 36/00

(52) U.S. Cl. CPC H04W 36/0072; H04W 36/0058; H04W 36/0069; H04W 36/00835; H04W 36/0085

(57) ABSTRACT

The disclosure relates to a 5G or 6G communication system for supporting a higher data transmission rate. Embodiments herein disclose methods for handling a lower layer triggered mobility (LTM) in a wireless network (1000) by a UE (100). The method includes receiving a RRC Reconfiguration including a LTM configuration having at least one of: a LTM candidate cell configuration, a LTM measurement configuration, and a LTM reference configuration from a network entity (200). Further, the method includes sending a RRC reconfiguration complete to the network entity (200) based on the RRC Reconfiguration, on completing the RRC reconfiguration successfully. Further, the method includes reusing one of: a L3 measurement result, and a part of the L3 measurement result for a LTM measurement, when the UE (100) is measuring the same reference signal for the L3 measurement result and the LTM measurement.

### TECHNICAL FIELD

Embodiments disclosed herein relate to wireless communication networks, and more particularly to managing lower layer triggered mobility in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In wireless technologies (like fifth generation new radio (5G NR)), devices (e.g., UEs or the like) can move across different cells. Mobility is performed using a procedure called cell reselection in an RRC_IDLE mode. Till, NR R17, the mobility is performed using a procedure called handover in an RRC_CONNECTED mode. Network controlled mobility applies to the UEs in the RRC_CONNECTED mode. It requires explicit RRC signalling to be triggered by a gNB in the NR. The handover in the NR usually comprises of three steps such as handover preparation step, handover execution step and handover completion step. The gNB may configure the UE to report measurements. Based on the reported measurements or based on its own understanding of a network topology, the gNB sends a RRC Reconfiguration message to handover the UE to another cell (called a target cell) from a source cell. The UE accesses the target cell and sends a RRC Reconfiguration complete message to the target cell. In an alternative way (introduced in Third Generation Partnership Project (3GPP) NR release 16), the gNB may configure the UE with the execution conditions for triggering handover. Once the execution conditions are satisfied, the UE may move to the target cell and send the RRC Reconfiguration complete. The 3GPP also introduced a new handover called Dual Active Protocol Stack (DAPS) handover procedure. The handover procedure maintains the source gNB connection after reception of the RRC message for handover and until releasing the source cell after successful random access to the target Gnb, in release 16. In case of the DAPS handover procedure, the UE continues the downlink user data reception from the source gNB until releasing the source cell and continues the uplink user data transmission to the source gNB until successful random access procedure to the target gNB. In all these methods, the UE performs the handover by sending layer 3 (RRC) messages which causes considerable signalling overhead and latency issues. The handover, DAPS handover, and conditional handover (CHO) can be referred to as layer 3 mobility.

Dual Connectivity: The dual connectivity or more technically multi-radio dual connectivity is specified by the 3GPP in specifications such as TS 37.340. A summary of the details on the dual connectivity are given below.

The NG-RAN facilitates Multi-Radio Dual Connectivity (MR-DC) operation, wherein the UE in the RRC_CONNECTED is configured to employ radio resources provided by two distinct schedulers situated in separate NG-RAN nodes. These nodes are connected via a non-ideal backhaul, with one providing access to NR (New Radio) and the other to either E-UTRA (Evolved UMTS Terrestrial Radio Access) or NR. One node serves as the master node (MN), while the other functions as the secondary node (SN). These nodes are linked via a network interface, and at least the MN is connected to a core network. The cell groups associated to the MN can be referred to as the MCG and the cell groups associated to the SN can be referred to as the SCG. The SN may configure the UE with multiple Data Radio Bearers (DRB) and optionally a Signalling Radio Bearer (SRB). In NR, the SRB configured by the SN is known as SRB3. Traditionally, wireless technologies restrict the amount and type of data that could be transferred over SRB3, for example, to ensure that there is sufficient control and knowledge about the behavior of the UE by the MN. For e.g. in NR-DC and NE-DC, In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received in a NR message used to recover the MCG link, such as within DLInformationTransferMRDC. Primary cell of MCG is known as PSCell.

In case of a dual connectivity, the UE may perform PSCellChange or Conditional PSCellChange mainly through layer 3 signalling.

In the context of the dual connectivity, the PSCellChange or the Conditional PSCellChange can be referred to also as layer 3 mobility. That is, the handover, the conditional handover, PSCellChange, Conditional PSCellChange etc. refers to L3 mobility. The PSCellChange or the Conditional PSCellChange can also be referred to herein as Secondary Cell group (SCG) layer 3 mobility and the handover and CHO as Master Cell Group (MCG) layer 3 mobility in the context of dual connectivity. The conditional handover, and the conditional PSCell change can be also referred to as conditional mobility. Further, the UE may receive RRC configuration for updating some of the security parameters.

Traditionally, for conditional mobility, the gNB configures the candidate cell configurations after the AS security is configured. However the measurement configurations for the conditional mobility can be provided before the AS security configuration. Similarly any reference configurations such as reference signal configurations can be also provided before the AS security is configured. This is done considering a balance between the security requirements and the network implementation flexibility. Further restrictions may be specified for the UE behavior for the measurement reporting etc., when the measurements are configured and the AS security is not configured.

Further, the 3GPP specifications such as technical specification (TS) 38.300, TS38.331, TS 38.321 V17.2.0 can be considered as relevant background. Further, the 3GPP release 18 is considering Lower Layers (L1/L2 layers) Triggered Mobility (also known as LTM) to solve the problem related to latency, signalling overhead etc. associated with the layer 3 mobility. As per the 3GPP, the goal of LTM is to enable a serving cell change via L1/L2 signalling, in order to reduce the latency, overhead and interruption time. The network (e.g., gNB or the like) may configure the UE with multiple candidate cells to allow fast application of configurations for candidate cells. The network may further send a Medium Access Control Control-element (MAC CE) or L1 signalling to dynamically switch the UE from the source cell to one of the configured candidate cells. Further, the LTM can be triggered based on L1 measurements rather than L3 measurements.

The 3GPP proposes to perform the LTM, without reset of lower layers (like Medium Access Control (MAC)) to avoid data loss and to reduce the additional delay of data recovery, wherever it is possible.

Further, the gNB may provide a LTMCandidateConfiguration. That is, the gNB may configure LTM candidate cells through one RRCReconfiguration message for a candidate target cell or through one CellGroupConfig for each candidate target cell or through any similar RRC structure or information element (IE) containing the similar fields. For example, a new IE LTM-CandidateConfig can be defined as ASN.1 sequence containing CellGroupConfig and some other information elements in the RRCReconfiguration. The gNB may further release or modify the candidate configurations. The UE may store the LTM configuration of other candidate cells even after moving to the candidate cell through the LTM. The gNB also may provide the UE with configuration for performing LTM measurements for different candidate frequencies and candidate cells and reporting based on the performed LTM measurements.

The NR R17 UE can be configured with MeasConfig 1E for performing layer 3 measurements. R17 v17.2.0 NR specification defines MeasConfig as below.

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList OPTIONAL, -- Need N |
| reportConfigToRemoveList | ReportConfigToRemoveList OPTIONAL, -- Need |

N

| | |
|---|---|
| reportConfigToAddModList | ReportConfigToAddModList OPTIONAL, -- Need |

N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |
| } | OPTIONAL, -- Need |

M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
  OPTIONAL, -- Need M
  ...,
  [[
```

| | |
|---|---|
| interFrequencyConfig-NoGap-r16 | ENUMERATED {true} |

```
  OPTIONAL -- Need R
  ]]
  }
```

Additional details and definitions of all the parameters for MeasConfig are present in 3GPP TS 38.331 V17.2.0.

The above information is presented as background information only to help the reader to understand the disclosure. Applicants have made no determination and make no assertion as to whether any of the above might be applicable as prior art with regard to the present application.

### DISCLOSURE OF INVENTION

### Solution to Problem

The principal object of the embodiments herein is to disclose methods and wireless network for handling co-existence and interaction of LTM (L1/L2 triggered mobility) with various RRC procedures, such as measurement evaluation and measurement reporting, L3 mobility, security key update, conditional handover and DAPS handover in the wireless network.

Another object of the embodiments herein is to configure the LTM.

Another object of the embodiments herein is to release the LTM.

Accordingly, the embodiments herein provide methods for handling a lower layer triggered mobility (LTM) in a wireless network. The method includes receiving, by a UE, a radio resource control (RRC) Reconfiguration including a LTM configuration having a LTM candidate cell configuration, a LTM measurement configuration, and a LTM reference configuration from a network entity. Further, the method includes sending, by the UE, a RRC reconfiguration complete to the network entity based on the RRC Reconfiguration, on completing the RRC reconfiguration successfully. Further, the method includes reusing, by the UE, one of: a L3 measurement result, and a part of the L3 measurement result for a LTM measurement, when the UE is measuring the same reference signal for the L3 measurement result and the LTM measurement.

In various embodiments, the network entity provides the LTM configuration including one or more of the LTM candidate cell configuration, the LTM reference configuration, and the LTM measurement configuration in the RRC Reconfiguration when an Access Stratum (AS) security has been activated.

In various embodiments, the network entity provides the LTM configuration including one or more of the LTM candidate cell configuration, the LTM reference configuration, and the LTM measurement configuration in the RRC Reconfiguration when a Signaling Radio Bearer 2 (SRB2) with at least one of one Data Radio Bearer (DRB) is setup and not suspended or when one of: a multicast multi-cast radio bearer (MRB), and the SRB2 are setup and not suspended.

In various embodiments, the network entity provides the LTM configuration for a Secondary Cell Group (SCG) in a New Radio Dual Connectivity (NR-DC) in the RRC Reconfiguration in a SRB3.

In various embodiments, the reference signal corresponds to same serving cell or same neighbor cell.

Accordingly, the embodiments herein provide methods for handling a lower layer triggered mobility in a wireless network. The method includes receiving, by a UE, a RRCReconfiguration including information for releasing a LTM configuration. Further, the method includes releasing, by the UE, the LTM configuration, based on the received RRC Reconfiguration.

Accordingly, the embodiments herein provide methods for handling a lower layer triggered mobility. The method includes receiving, by a first network entity, a DAPS handover command in the first network entity from a second network entity. Further, the method includes sending, by the first network entity, the DAPS handover command to the UE. Further, the method includes releasing, by the first network entity, a LTM configuration prior to sending the DAPS handover command to the UE.

In various embodiments, the method includes skipping, by a second network entity, configuring LTM configuration until the DAPS handover is completed.

Accordingly, the embodiments herein provide methods for handling a lower layer triggered mobility in a wireless network. The method includes sending, by a network entity, a RRC Reconfiguration including a LTM configuration having one or more of a LTM candidate cell configuration, a LTM measurement configuration, and a LTM reference configuration to a User Equipment (UE). Further, the method includes receiving, by the network entity, a RRC reconfiguration complete from the UE based on the RRC Reconfiguration.

Accordingly, the embodiments herein provide a UE including a LTM controller coupled with a processor and a memory. The LTM controller is configured to receive a RRC Reconfiguration including a LTM configuration having at least one of a LTM candidate cell configuration, a LTM measurement configuration, and a LTM reference configuration from a network entity. Further, the LTM controller is configured to send a RRC reconfiguration complete to the network entity based on the RRC Reconfiguration, on completing the RRC reconfiguration successfully. Further, the LTM controller is configured to reuse one of: a L3 measurement result and a part of the L3 measurement result for the LTM measurement when the UE is measuring the same reference signal for the L3 measurement result and the LTM measurement.

Accordingly, the embodiments herein provide a UE including a LTM controller coupled with a processor and a memory. The LTM controller is configured to receive a RRC Reconfiguration including information for releasing a LTM configuration. Further, the LTM controller is configured to release the LTM configuration based on the RRC Reconfiguration.

Accordingly, the embodiments herein provide a network entity including a LTM controller coupled with a processor and a memory. The LTM controller is configured to receive a DAPS handover command in the first network entity from a second network entity. Further, the LTM controller is configured to send the DAPS handover command to the UE. Further, the LTM controller is configured to release a LTM configuration prior to sending the DAPS handover command to the UE.

Accordingly, the embodiments herein provide a network entity including a LTM controller coupled with a processor and a memory. The LTM controller is configured to send a RRC Reconfiguration including a LTM configuration having a LTM candidate cell configuration, a LTM measurement configuration, and a LTM reference configuration to a UE. Further, the LTM controller is configured to receive a RRC reconfiguration complete from the UE based on the RRC Reconfiguration.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a LTM, according to the embodiments as disclosed herein;

FIG. 2 shows various hardware components of a UE, according to the embodiments as disclosed herein;

FIG. 3 shows various hardware components of a network entity, according to the embodiments as disclosed herein;

FIG. 4 and FIG. 5 are flow charts illustrating a method, implemented by the UE, for handling the LTM in the wireless network, according to the embodiments as disclosed herein;

FIG. 6 and FIG. 7 are flow charts illustrating a method, implemented by the network entity, for handling the LTM in the wireless network, according to the embodiments as disclosed herein;

FIG. 8 depicts a process of making LTM and L3 measurements, according to embodiments as disclosed herein;

FIG. 9 depicts a process of a L3 HO interacting with the LTM, according to embodiments as disclosed herein;

FIG. 10 depicts the process of updating a security key while handling the LTM, according to embodiments as disclosed herein;

FIG. 11 depicts the process of a DAPS interacting with the LTM, according to embodiments as disclosed herein; and

FIG. 12 depicts the process of performing conditional mobility configuration, according to embodiments as disclosed herein.

FIG. 13 illustrates a structure of a UE according to embodiments of the disclosure.

FIG. 14 illustrates a structure of a network entity according to embodiments as disclosed herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein provide methods for handling a LTM in a wireless network.

The method includes receiving, by a UE, a RRC reconfiguration including a LTM configuration having a LTM candidate cell configuration, a LTM measurement configuration, and a LTM reference configuration from a network entity. Further, the method includes sending, by the UE, a RRC reconfiguration complete to the network entity based on the RRC Reconfiguration, on completing the RRC reconfiguration successfully. Further, the method includes reusing, by the UE, one of: a L3 measurement result, and a part of the L3 measurement result for a LTM measurement, when the UE is measuring the same reference signal for the L3 measurement result and the LTM measurement.

The proposed method can be used for handling the co-existence and interaction of LTM (L1/L2 triggered mobility) with various RRC procedures, such as measurement evaluation and measurement reporting, L3 mobility, security key update, conditional handover, and DAPS handover without wasting the signaling resource.

Below are the technical advantages of the proposed method:

1. Reuse of layer 3 measurements: When the UE reuses L3 measurements for L1 measurements reporting, the UE doesn't have to implement the L1 measurements and reporting separately, or can implement L1 measurements and reporting for a lesser number of LTM candidate cells. The reduced measurements and reporting will also result in power savings with less processing complexity.

2. One shot LTM release: A one shot release of LTM configuration needs much less signalling than releasing each of the configurations separately. This also enables smooth interworking with layer3 handover and also enables interworking with the network nodes which doesn't support the LTM-such nodes just need to implement a single flag to release entire LTM configurations rather than using a full configuration.

3. DAPS and LTM interworking: Leads to simpler implementation in the UE and the network nodes. The proposed method can be used to avoid the complex interworking between a gNB CU and a gNB DU as well as different layers/controllers in UE protocol stack.

4. LTM configuration after AS security and SRB2/DRB or SRB2/MRB: The proposed method can be used to prevent the man in the middle attacks and other security issues. For example, without the proposed method, an intruder might know the radio bearer configurations for the UE which may lead to privacy violations. This also simplifies the UE and network implementation as additional checks for complex security handling could be reduced.

5. Use of SRB3: The proposed method can be used to simplify the LTM configurations for Intra-SN LTM. This also reduces the internode signaling overhead between MN and SN as well as signalling overhead on the air interface.

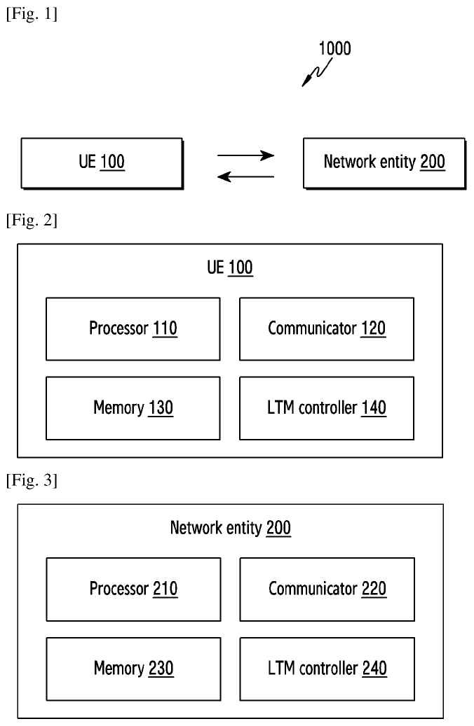

Referring now to the drawings, and more particularly to FIGS. 1 through 12, where similar reference characters denote corresponding features consistently throughout the figures, there are shown at least one embodiment.

FIG. 1 illustrates a wireless network (1000) for handling a LTM, according to the embodiments as disclosed herein. The wireless network (1000) can be, for example, but not limited to a fourth generation (4G) network, a fifth generation (5G) network, an Open Radio Access Network (ORAN) or the like. In various embodiments, the wireless network (1000) includes a UE (100) and a network entity (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (200) can be, for example, but not limited to a gNB, a eNB, a new radio (NR) trans-receiver or the like.

The UE (100) receives a RRC Reconfiguration including a LTM configuration having a LTM candidate cell configuration, a LTM measurement configuration, and a LTM reference configuration from the network entity (200). Further, the UE (100) sends the RRC reconfiguration complete to the network entity (200) based on the RRC Reconfiguration, on completing the RRC reconfiguration successfully. Further, the UE (100) reuses one of: a L3 measurement result, and a part of the L3 measurement result for a LTM measurement, when the UE (100) is measuring the same reference signal for the L3 measurement result and the LTM measurement.

In another embodiment, the UE (100) receives the RRCReconfiguration includes information for releasing the LTM configuration. Based on the received RRC Reconfiguration, the UE (100) releases the LTM configuration.

In various embodiments, the network entity (200) triggers the DAPS handover command to the UE (100) to another network entity (not shown). Further, the network entity (200) releases a LTM configuration prior to triggering the DAPS handover command to the UE (100).

In another embodiment, the network entity (200) sends the RRC Reconfiguration comprising the LTM configuration having the LTM candidate cell configuration, the LTM measurement configuration, and the LTM reference configuration to the UE (100) after AS security is activated. Further, the network entity (200) receives the RRC reconfiguration complete from the UE (100) based on the RRC Reconfiguration.

All the embodiments below may be based on the UE's capabilities as reported to the network entity (200). There may be some UEs which don't support the provided capabilities. Embodiments herein show an example SEQUENCE below which may be used for configuring LTM.

```
RRCReconfiguration-v18xx-Ies ::= SEQUENCE {
Ltm-Config LTM-Config OPTIONAL,
<other IEs>
  }
  LTM-Config ::= SEQUENCE {
    candLTM-Reconfiguration SEQUENCE CandLTM Reconfiguration
  OPTIONAL -Need M,
LTMMeasConfig LTMMeasConfig OPTIONAL -Need M,
nonCriticalExtension RRCReconfiguration-v1xxx-Ies
                    OPTIONAL,
LTMRefConfig LTMRefConfigType OPTIONAL -Need M,
}
CandLTM-Reconfiguration ::= SEQUENCE {
  candLTM-ReconfigToRemoveList CandLTM-ReconfigToRemoveList OPTIONAL,
  -- Need N
  candLTM-ReconfigToAddModList CandLTM-ReconfigToAddModList
  OPTIONAL, -- Need N
  ...
}
CandLTM-ToAddModList ::= SEQUENCE (SIZE (1.. maxNr)) OF CandLTM-ToAddMod
CandLTM-ToAddMod ::= SEQUENCE {
  candLTM-ReconfigId CandLTM-ReconfigId,
  candLTM-Reconfig CandLTM-Reconfig,
}
CandLTM-Reconfig ::= SEQUENCE {
candLTM-CellGroupConfig CellGroupConfig,
measConfig MeasConfig OPTIONAL,
radioBearerConfig RadioBearerConfig OPTIONAL,
<other IEs>
}
```

In various embodiments, the network entity (e.g., gNB) (200) sends the LTM configuration to the UE (100) in the RRC messages. A gNB Centralized Unit (CU) may also send LTM configuration including the LTM measurement configuration to a gNB Distributed Unit (DU). The LTM measurement configuration send from the gNB CU to the gNB DU includes L1 measurement configuration for LTM, including the measurement objects for LTM measurements (such as the frequencies to be measured, cells to be measured for the LTM measurements), measurement identifiers for the LTM measurements, measurement gap configurations for the LTM measurements, reporting configuration including the measurement filters/thresholds/offsets etc. for the LTM measurements etc. The LTM measurement configuration may also include CSI resource configurations for LTM.

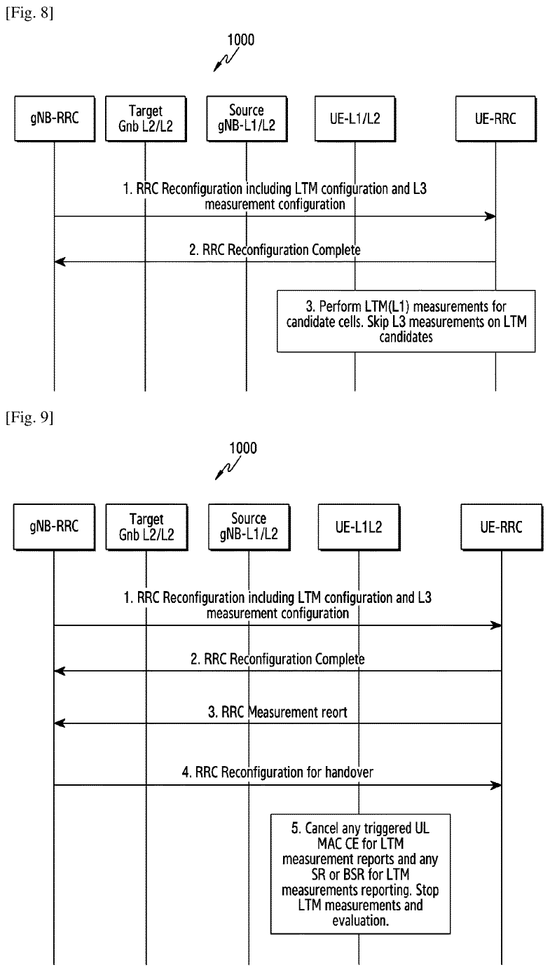

Measurement Configuration: The UE (100) can be configured by the gNB with different measurement configurations for both layer 3 mobility (for e.g., using MeasConfig IE in R17 NR) and the LTM. The UE (100) has been configured with measurement configurations for the layer3 mobility (measurements configured/performed/reported for layer 3 mobility (for e.g., configured through R17 MeasConfig 1E), herein after referred to as L3 measurements) and LTM (measurements configured/performed/reported for LTM, herein after referred to as LTM measurements), performs both L3 measurements and LTM measurements (as depicted in FIG. 8).

In various embodiments, when the UE (100) is configured for performing the L3 measurements and the LTM measurements on the same frequency, the UE (100) performs the L3 measurements on all the cells on the frequency irrespective of whether these cells are configured the for the LTM measurements, unless explicitly prohibited or is configured to measure only on specific cells. For L3 measurements, the explicit prohibition is done using list of excludedCells (as configured using excludedCellsToAddModList/excludedCellsToRemoveList) and configuration to measure only specific cells (list of allowedCells) (as done using allowedCellsToAddModList/allowedCellsToRemoveList).

While measuring the same reference signal (e.g., in a same serving cell or neighbor cell) for both the L3 measurements and the LTM measurements, the UE (100) reuses the entire LTM measurement results or part of the LTM measurement results for the layer 3 measurements or reuse the L3 measurement results or part of the L3 measurement results for the LTM measurements. In other words, when the UE (100) is configured for the L3 measurements and the LTM measurements, the UE (100) avoids repetition of the measurements on the same cell and the same reference signal for both LTM measurements and L3 measurements. In an example, the UE (100) may perform layer1 measurements for the LTM. The UE (100) applies a L3 filter and reports the measurements to the network entity (200) through the L3 measurement reports (MeasReport). The UE (100) also sends the layer1 measurement results to the gNB through a MAC CE and L3 measurement reports in RRC based on the same set of measurements available.

In various embodiments, the gNB CU includes any of the LTM candidate cells, that it has configured to the UE (100) in a list of excludedCells or includes only the cells other than the LTM candidate cells, it has configured to the UE (100) in the list of allowedCells for restricting the UE (100) from performing L3 measurements on the same cell for which LTM has been configured.

In various embodiments, the UE (100) is configured to perform L3 measurements on the frequency and has received LTM configuration including LTM candidate cells. The UE (100) excludes performing L3 measurements on the LTM candidate cells. The L3 measurement configuration and the LTM configuration may come from different RRC messages like RRC Reconfiguration or RRC Resume or different RRC Reconfiguration messages. Further, the UE (100) excludes reporting the L3 measurements for the LTM candidate cells on the frequency (as depicted in FIG. 8). In an example, the UE (100) (e.g., NR UE (100) or the like) has been configured with MeasConfig with a measurement object having SSB frequency F1. On the same frequency F1, the UE (100) has been configured for the LTM with the LTM candidate cell C1 and C2. While performing measurements or reporting measurements for L3 mobility, the UE (100) does not consider C1 and C2 even when C1 and C2 are detected. Consider that UE (100) has detected C1, C2, C3 and C4 on F1, the UE (100) performs and reports measurements only for C3 and C4. In other words, in this embodiment, the UE (100) behaves as if it has received the LTM candidate cells as excludedCells for the L3 measurements. That is, the UE (100) considers any LTM candidate cell as an excludedCell for L3 measurements even though it is not in the received excludedCellList.

L3 mobility and LTM: The UE (100) performs the L3 mobility upon reception of the RRC reconfiguration message asking the UE (100) to perform handover, or upon execution of the conditional reconfiguration (e.g., CHO, CPA (Conditional PSCell Addition) or CPC). In the NR, the RRC reconfiguration message asking the UE (100) to perform the handover can be RRCReconfiguration message (including reconfigurationWithSync) and the spCellConfigCommon in the reconfiguration WithSync (includes physical cell identifier (physCellId)). The L3 mobility ends successfully once the UE (100) moves to the target cell. The UE (100) may perform random access while moving to the target cell in most cases, except in some cases, like when the UE (100) is in the SCG deactivated in the target cell or when the RACHless handover is configured for Non Terrestrial Network cell. The UE (100) applies the target configuration during the handover execution. In DAPS handover, the UE (100) may keep both the source and target configurations, till the target configuration is explicitly released by the network entity (200). The L3 mobility can fail, if the UE (100) has not successfully moved to the target cell due to handover failure or due to inability to apply the provided configuration (for example).

The UE (100) performs the LTM upon receiving cell switch command from the network entity (200) (and may also decide to perform cell switch if some criteria configured matches). It is also possible that the LTM trigger occurs due to other actions than the reception of L1 or L2 message from gNB-(For example) upon radio link failure, if the UE (100) selects the cell which is the LTM candidate cell, the UE (100) may behave as if the LTM is triggered, i.e. perform actions upon LTM trigger, if it is configured by the network to do so. The LTM is successfully completed if the UE (100) has successfully switched to the target cell. The UE (100) may perform random access successfully or may make an uplink transmission (on L1 channels like Physical Uplink Control Channel (PUCCH)/Physical Uplink Shared Channel (PUSCH)) to indicate successful completion of LTM.

While performing the L3 mobility, the UE (100) cancels, (if any), UL MAC CE triggered for reporting LTM measurements. That is, on reception of the RRC message for the L3 mobility or performing conditional handover, the UE (100) cancels the UL MAC CE triggered for sending LTM measurements to the gNB. This process is depicted in FIG. 9.

While performing the L3 mobility, the UE (100) cancels, (if any) triggered SR (Scheduling Request) or Buffer Status Report (BSR) for reporting LTM measurements. Upon the L3 handover, the UE (100) cancels (if any) the SR or the BSR triggered for sending LTM measurements to the gNB.

While performing the MCG L3 Mobility, the UE (100) cancels, (if any) UL MAC CE triggered for reporting the LTM measurements, triggered SR and triggered BSR for the LTM measurement reporting to master network (MN) (and not to a secondary network (SN)). Alternatively, while performing the MCG L3 Mobility, the UE (100) cancels (if any) the UL MAC CE triggered for reporting the LTM measurements as well as SR and BSR for reporting the LTM measurements to any of MN and SN.

While performing a SCG L3 Mobility, the UE (100) cancels, (if any) UL MAC CE triggered for reporting the LTM measurements, triggered SR and triggered BSR for the LTM measurements reporting to the SN (and not to the MN). Alternatively, while performing the SCG L3 Mobility, the UE (100) cancels (if any) UL MAC CE triggered for reporting LTM measurements as well as SR and BSR for reporting LTM measurements to any of SN and MN.

While performing the L3 Mobility, the UE (100) stops the LTM measurements and LTM measurement evaluation. While performing MCG L3 mobility, the UE (100) stops the LTM measurements and measurement evaluation for the MCG, and not for SCG. Alternatively, while performing MCG L3 mobility, the UE (100) stops the LTM measurements and measurement evaluation for LTM for MCG, and also for SCG.

While performing the SCG L3 mobility, the UE (100) stops the LTM measurements and measurement evaluation for the SCG, and not for the MCG. Alternatively, while performing SCG L3 mobility, the UE (100) stops the LTM measurements and measurement evaluation for the SCG, and also for the MCG.

While performing the LTM, the UE (100) stops the layer 3 measurements and measurement evaluation for layer 3 mobility. While performing a MCG LTM, the UE (100) stops the layer 3 measurements and measurement evaluation for the MCG, and not for SCG. Alternatively, while performing the MCG LTM, the UE (100) stops the layer 3 measurements and measurement evaluation for the MCG, and also for the SCG.

While performing a SCG LTM, the UE (100) stops the layer 3 measurements and measurement evaluation for the SCG, and not for the MCG. Alternatively, while performing the SCG LTM, the UE (100) stops the layer 3 measurements and measurement evaluation for the SCG, and also for MCG.

In various embodiments, while performing layer 3 mobility, the UE (100) clears the entire LTM configuration.

In an alternate embodiment, while performing the layer 3 mobility, a part of LTM configuration is cleared and a part of LTM configuration is kept. Configuration cleared can include some of the LTM candidate cell configuration and the LTM reference configuration. In various embodiments, while performing the layer 3 mobility, the UE (100) keeps the LTM measurement configuration such as frequencies to be measured for LTM, the measurement reporting configuration for LTM, and the measurement identifiers for the LTM.

In various embodiments, the UE (100) receives information from the gNB whether the LTM configuration (LTM configuration in this embodiment, can be, a part of LTM configuration also) needs to be released, or kept. The UE (100) may receive a RRC IE such as a flag, which if set or set to true, the UE (100) releases the LTM configuration upon performing the L3 mobility. If the flag is set to false or not set, the UE (100) keeps the LTM configuration. Alternatively, the UE (100) may receive the RRC IE (such as a flag), which if set or set to true, the UE (100) releases the LTM configuration upon performing L3 mobility and if not set or set to false, the UE (100) keeps the LTM configuration upon performing L3 mobility.

In various embodiments, while performing layer 3 inter-gNB mobility, the UE (100) clears the LTM configuration.

In various embodiments, while performing layer 3 inter-gNB mobility, the part of LTM configuration is cleared autonomously and the part of LTM configuration is kept unless explicitly released by the gNB. Configuration cleared can include the candidate cell configuration and the LTM reference configuration. In various embodiments, while performing the layer 3 inter-gNB mobility, the UE (100) keeps LTM measurement configuration (such as frequencies to be measured for LTM, the measurement reporting configuration for LTM, and the measurement identifiers for LTM etc.), unless explicitly released by the gNB.

LTM and Security Key Update: In various embodiments, the UE (100) clears the LTM configuration upon security key update. In various embodiments, a NR UE (100) clears the LTM candidate cell configuration upon receiving RRCReconfiguration including masterKeyUpdate or nextHopChainingCount or keySetChangeIndicator. FIG. 10 depicts the process of updating the security key.

In various embodiments, the NR UE (100) clears LTM candidate cell configuration upon receiving the RRCReconfiguration including masterKeyUpdate or nextHopChainingCount or keySetChangeIndicator during the handover (i.e., cleared when the primary cell is changed).

In various embodiments, the NR UE (100) clears the LTM candidate cell configuration upon receiving RRCReconfiguration including a masterKeyUpdate or a nextHopChainingCount or a keySetChangeIndicator and a physCellId in ServingCellConfigCommon in the reconfiguration WithSync in spCellConfig includes a new physical cell identifier than the current cell. In various embodiments, the NR UE (100) clears the LTM reference configuration upon receiving RRCReconfiguration including a masterKeyUpdate or a nextHopChainingCount or a keySetChangeIndicator and the physCellId in ServingCellConfigCommon in the reconfiguration WithSync in spCellConfig includes a new physical cell identifier than the current cell.

In various embodiments, the NR UE (100) clears the MCG LTM candidate cell configuration upon receiving the RRCReconfiguration including the masterKeyUpdate or the nextHopChainingCount or the keySetChangeIndicator and the physCellId in ServingCellConfigCommon in the reconfiguration WithSync in spCellConfig of MCG includes a new physical cell identifier than the current cell. In various embodiments, the NR UE (100) clears the MCG LTM reference configuration upon receiving the RRCReconfiguration including the masterKeyUpdate or nextHopChainingCount or keySetChangeIndicator and the physCellId in ServingCellConfigCommon in the reconfiguration WithSync in spCellConfig of MCG includes a new physical cell identifier than the current cell.

In various embodiments, the NR UE (100) clears a SCG LTM candidate cell configuration upon receiving RRCReconfiguration including sk-counter (SN Counter) and the physCellId in ServingCellConfigCommon in the reconfiguration WithSync in spCellConfig of SCG includes a new physical cell identifier than the current cell. In various embodiments, the NR UE (100) clears the SCG LTM reference configuration upon receiving RRCReconfiguration including sk-counter (SN Counter) and the physCellId in ServingCellConfigCommon in the reconfiguration WithSync in spCellConfig of SCG includes a new physical cell identifier than the current cell.

In various embodiments, the UE (100) clears the LTM candidate cell configuration and/or LTM reference configuration upon the security key update. In various embodiments, the UE (100) clears the MCG LTM candidate cell configuration and/or LTM reference configuration upon the MCG security key update. In various embodiments, the UE (100) clears the SCG LTM candidate cell configuration and/or LTM reference configuration upon the SCG security key update.

LTM and Inter-RAT HO: Upon successful completion of the mobility from NR, the NR UE (100) releases the LTM configuration including the LTM candidate cell configuration, the LTM reference configuration, and the LTM measurement configuration etc.

In various embodiments, for the handover to the NR from a Long Term Evolution (LTE) or other RAT, the gNB excludes including LTM configuration.

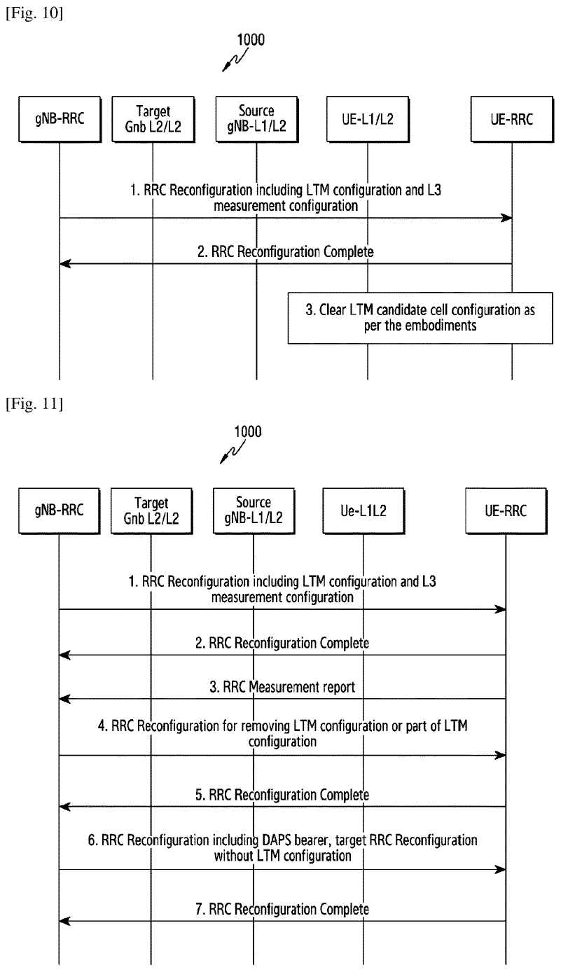

LTM and DAPS: FIG. 11 depicts the process of DAPS interacting with the LTM. In various embodiments, if the UE (100) performs the DAPS handover, the UE (100) releases LTM configuration configured by a source gNB including at least some of LTM measurement configuration, LTM candidate cell configuration, LTM reference configuration etc. In various embodiments, if a DAPS bearer is configured, the gNB skips configuring LTM configuration (including at least one of LTM measurement configuration, LTM candidate cell configuration, LTM reference configuration etc.). The gNB releases the LTM configuration (if configured), on configuring DAPS bearer and adds the LTM configuration again on releasing DAPS bearer. Further, the gNB may release the DAPS bearer, while performing LTM configuration.

In various embodiments, the source gNB releases the LTM configuration before sending the DAPS handover command to the UE (100). The target gNB skips configuring LTM configuration until DAPS handover is completed.

An example specification changes for the above embodiment as per 3gpp specification TS 38.300 is given below:

1. Only source and target PCell are used during DAPS handover. Carrier Aggregation (CA), Dual Connectivity (DC), Supplementary Uplink (SUL), multi-TRP, Ethernet Header Compression (EHC), CHO, Unified Data Convergence (UDC), NR sidelink configurations, vehicle to everything (V2X) sidelink configurations and LTM configuration are released by the source gNB before the handover command is sent to the UE (100) and are not configured by the target gNB until the DAPS handover has completed (i.e., at earliest in the same message that releases the source PCell).

In an alternative embodiment, the gNB may configure the DAPS bearer and the LTM configuration to the UE (100) simultaneously. In this case, upon receiving a handover command requesting a DAPS handover, the UE (100) suspends LTM measurements, evaluation and reporting, stops sending any LTM measurements towards the source cell and stops receiving the cell switch command from the source cell. While being configured both DAPS bearer and LTM configuration, the UE (100) sends the UL MAC CE for reporting LTM measurements to the target gNB alone and not to the source gNB, if the DAPS handover is successful. Further, the DL MAC CE for a LTM cell switch will be send from the target gNB (and not from the source gNB) to the UE (100), on the DAPS handover being successful even when the source configuration is not released. The UE (100) releases the LTM configuration when the source configuration is released. If the DAPS handover is failed, the UE (100) resumes LTM measurements, evaluation and reporting the LTM measurements to the source cell and can receive the cell switch command from the source cell.

In an alternate embodiment, the source gNB releases the LTM configuration on the source cell before the LTM command is send, but the target gNB may configure the LTM configuration in the handover command.

LTM and SRB3: In various embodiments, the gNB includes the LTM configuration in the RRC Reconfiguration included in SRB3 even when RRC Reconfiguration is not received via a DLInformationTransferMRDC.

This may be captured in TS 38.331 as below:

a. In (NG)EN-DC and NR-DC, SRB3 can be used for measurement configuration and reporting, for UE (100) assistance (re-)configuration and reporting for power savings, for IP address (re-)configuration and reporting for IAB-nodes, to (re-)configure MAC, RLC, BAP, physical layer and RLF timers and constants of the SCG configuration, and to reconfigure PDCP for DRBs associated with the S-KgNB or SRB3, and to reconfigure SDAP for DRBs associated with S-KgNB in NGEN-DC and NR-DC, and to add/modify/release conditional PSCell change configuration and to configure LTM configuration, provided that the (re-)configuration does not require any MN involvement, and to transmit RRC messages between the MN and the UE (100) during fast MCG link recovery. In (NG)EN-DC and NR-DC, only measConfig, radioBearerConfig, conditionalReconfiguration, bap-Config, iabIP-AddressConfigurationList, otherConfig,LTM-Config and/or secondaryCellGroup are included in RRCReconfiguration received via SRB3, except when RRCReconfiguration is received within DLInformationTransferMRDC.

Conditions for LTM configuration and Measurement reporting: In various embodiments, the gNB includes the LTM configuration in RRC Reconfiguration only when AS security has been activated. In various embodiments, the gNB includes the LTM configuration in RRC Reconfiguration only when SRB2 with at least one of one DRB is setup and not suspended or when multicast MRB or, for Integrated Access and Backhaul (IAB), SRB2, are setup and not suspended.

In various embodiments, the gNB includes the LTM candidate cell configuration in the RRC Reconfiguration only, when AS security has been activated. In various embodiments, the gNB includes the LTM candidate cell configuration in the RRC Reconfiguration only when SRB2 with at least one of one DRB or multicast MRB is setup and not suspended. In various embodiments, the gNB includes the LTM candidate cell configuration in RRC Reconfiguration only when multicast MRB or, for IAB, SRB2, are setup and not suspended.

In various embodiments, the gNB includes the LTM measurement configuration in RRC Reconfiguration even when AS security has not been activated. In various embodiments, the UE (100) reports the LTM measurements (for e.g., send UL MAC CE including LTM measurements) only, after the AS security has been activated even if it is configured before AS security activation.

In various embodiments, the gNB may include the LTM measurement configuration in the RRC Reconfiguration irrespective of whether SRB2 and DRB or multicast MRB or, for IAB, SRB2 is setup or suspended. In various embodiments, the gNB includes the LTM candidate cell configuration in the RRC Reconfiguration irrespective of whether SRB2 and DRB or multicast MRB or, for IAB, SRB2 are setup and not suspended.

In various embodiments, while sending the LTM configuration to the UE (100), the MN does not include the MRDC-SecondaryCellGroupConfig. The UE (100) keeps the secondary cell group configuration at the time of LTM execution irrespective of whether the reference configuration has been configured or not, or whether LTM configuration includes fullconfig.

LTM and CHO: In various embodiments, the gNB excludes including conditionalReconfiguration (as defined in TS 38.331) within the LTM configuration in the RRC Reconfiguration message. In various embodiments, the gNB excludes including LTM configuration within conditionalReconfiguration IE in the RRC reconfiguration message.

In various embodiments, if the gNB has configured LTM candidate cells for the UE (100), the gNB excludes configuring conditional reconfiguration for any cells. The gNB releases LTM candidate cells before/while configuring any candidate cells for conditional reconfiguration.

In various embodiments, if the gNB has configured LTM candidate cells for the UE (100), the gNB excludes configuring any LTM candidate cells. The gNB releases any configured candidate cells for conditional reconfiguration before/while configuring any LTM candidate cells.

In various embodiments, the gNB excludes configuring the LTM candidate cell configuration (LTMConfig) and conditional reconfiguration configuration together for the same candidate cell. In an example, if the gNB has configured cell C1, C2, C3 as LTM candidate cells in the frequency F1, the gNB excludes C1, C2, C3 of F1 from the cells for configuring conditional handover. Similarly, if a SN in NR-NR DC has configured cells C4, C5, C6 in a frequency F2 as LTM candidate cells, the SN gNB excludes C4, C5, and C6 in frequency F2 from the list of cells configured for Conditional PSCell Change.

FIG. 2 shows various hardware components of the UE (100), according to the embodiments as disclosed herein. In various embodiments, the UE (100) includes a processor (110), a communicator (120), a memory (130) and a LTM controller (140). The processor (110) is coupled with the communicator (120), the memory (130) and the LTM controller (140).

The LTM controller (140) receives the RRC Reconfiguration including the LTM configuration having the LTM candidate cell configuration, the LTM measurement configuration, and the LTM reference configuration from the network entity (200). Further, the LTM controller (140) sends the RRC reconfiguration complete to the network entity (200) based on the RRC Reconfiguration, on completing the RRC reconfiguration successfully. Further, the LTM controller (140) reuses one of: the L3 measurement result, and the part of the L3 measurement result for a LTM measurement, when the UE (100) is measuring the same reference signal for the L3 measurement result and the LTM measurement.

In another embodiment, the LTM controller (140) receives the RRCReconfiguration comprising information for releasing the LTM configuration. Based on the received RRC Reconfiguration, the LTM controller (140) releases the LTM configuration.

The LTM controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In various embodiments, the communicator (120) includes an electronic circuit specific to a standard that enables wired or wireless communication. The communicator (120) is configured to communicate internally between internal hardware components of the UE (100) and with external devices via one or more networks.

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

FIG. 3 shows various hardware components of the network entity (200), according to the embodiments as disclosed herein. In various embodiments, the network entity (200) includes a processor (210), a communicator (220), a memory (230) and a LTM controller (240). The processor (210) is coupled with the communicator (220), the memory (230) and the LTM controller (240).

The LTM controller (240) of the first network entity receives the DAPS handover command in the first network entity from the second network entity. The DAPS handover command is received by the first network entity as part of a handover request acknowledge send from the second network entity in response to the handover request send by the first network entity, for inter-network node handovers. It is also possible that the first network entity acts as the second network entity when the handover is intra-network node handover. Further, the LTM controller (240) of the first network entity sends the DAPS handover command to the UE (100). Further, the LTM controller (240) of the first network entity releases the LTM configuration prior to sending the DAPS handover command to the UE (100). Furthermore, the LTM controller (240) of the second network entity skips configuring LTM configuration until the DAPS handover is completed.

In another embodiment, the LTM controller (240) sends the RRC Reconfiguration comprising the LTM configuration having the LTM candidate cell configuration, the LTM measurement configuration, and the LTM reference configuration to the UE (100). Further, the LTM controller (240) receives the RRC reconfiguration complete from the UE (100) based on the RRC Reconfiguration.

In another embodiment, the LTM controller (240) provides the LTM configuration including the LTM candidate cell configuration, the LTM reference configuration, and the LTM measurement configuration in the RRC Reconfiguration when the AS security has been activated.

In another embodiment, the LTM controller (240) provides the LTM configuration including the LTM candidate cell configuration, the LTM reference configuration, and the LTM measurement configuration in the RRC Reconfiguration when a Signaling Radio Bearer 2 (SRB2) with at least one of one DRB is setup and not suspended or when one of: an MRB, and the SRB2 are setup and not suspended.

In another embodiment, the LTM controller (240) provides the LTM configuration for the SCG in the NR-DC in the RRC Reconfiguration included in a SRB3.

The LTM controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

In various embodiments, the communicator (220) includes an electronic circuit specific to a standard that enables wired or wireless communication. The communicator (220) is configured to communicate internally between internal hardware components of the UE (100) and with external devices via one or more networks.

Although the FIG. 3 shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the disclosure. One or more components can be combined together to perform same or substantially similar function in the network entity (200).

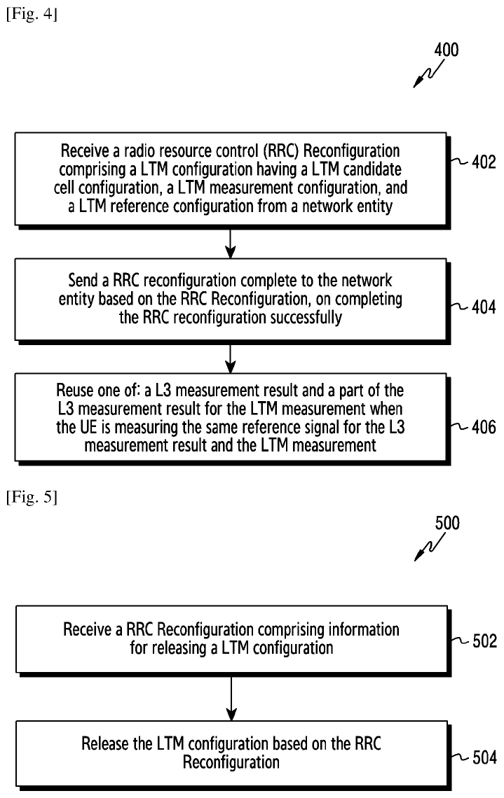

FIG. 4 and FIG. 5 are flow charts (400 and 500) illustrating a method, implemented by the UE (100), for handling the LTM in the wireless network (1000), according to the embodiments as disclosed herein.

As shown in FIG. 4, the operations (402-406) are handled by the LTM controller (140). At 402, the method includes receiving the RRC Reconfiguration including the LTM configuration having the LTM candidate cell configuration, the LTM measurement configuration, and the LTM reference configuration from the network entity (200). At 404, the method includes sending the RRC reconfiguration complete to the network entity (200) based on the RRC Reconfiguration, on completing the RRC reconfiguration successfully. At 406, the method includes reusing one of: the L3 measurement result, and the part of the L3 measurement result for a LTM measurement, when the UE (100) is measuring the same reference signal for the L3 measurement result and the LTM measurement.

As shown in FIG. 5, the operations (502 and 504) are handled by the LTM controller (140). At 502, the method includes receiving the RRCReconfiguration including information for releasing the LTM configuration. At 504, the method includes releasing the LTM configuration based on the received RRC Reconfiguration.

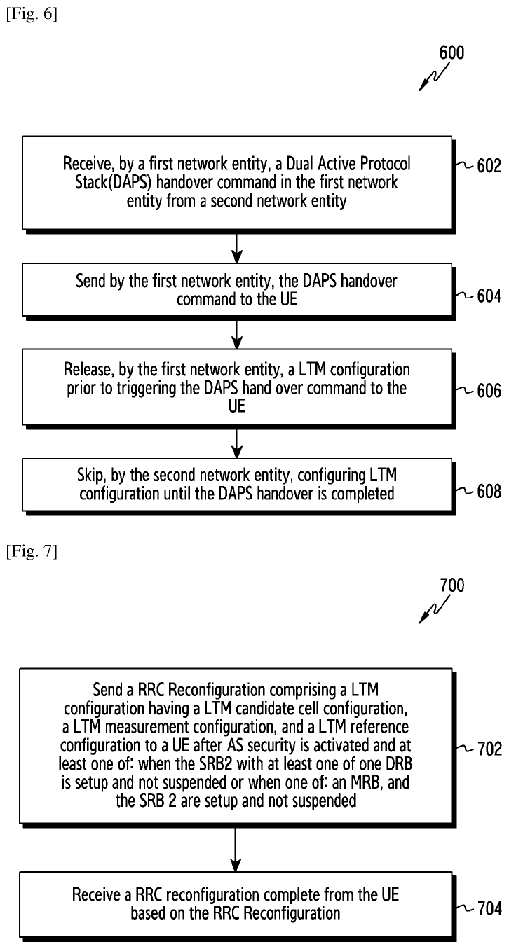

FIG. 6 and FIG. 7 are flow charts (600 and 700) illustrating a method, implemented by the network entity (200), for handling the LTM in the wireless network (1000), according to the embodiments as disclosed herein.

As shown in FIG. 6, the operations (602-608) are handled by the controller (240). At 602, the method includes receiving, by the first network entity, the DAPS handover command in the first network entity (200) from the second network entity. The DAPS handover command may be received by the first network entity as part of the handover request acknowledge send from the second network entity in response to the handover request send by the first network entity, for inter-network node handovers. It is also possible that first network entity acts as the second network entity when the handover is intra-network node handover. At 604, the method includes sending, by the first network entity, the DAPS handover command to the UE (100). At 606, the method includes releasing, by the first network entity, the LTM configuration prior to sending the DAPS handover command to the UE (100). At 608, the method includes skipping, by the second network entity, configuring the LTM configuration until the DAPS handover is completed. In NR, first network entity is the source gNB and second network entity is the target gNB.

As shown in FIG. 7, the operations (702 and 704) are handled by the LTM controller (240). At 702, the method includes sending the RRC Reconfiguration including the LTM configuration having the LTM candidate cell configuration, the LTM measurement configuration, and the LTM reference configuration to the UE (100) after AS security is activated and at least one of: when the SRB2 with at least one of one DRB is setup and not suspended or when one of: the MRB, and the SRB2 are setup and not suspended. At 704, the method includes receiving the RRC reconfiguration complete from the UE (100) based on the RRC Reconfiguration.

FIG. 8 depicts the process of making LTM and L3 measurements, according to embodiments as disclosed herein. At step 1, the RRC layer of the gNB sends the RRC Reconfiguration including the LTM configuration and the L3 measurement configuration to the RRC layer of the UE (100). At step 2, the RRC layer of the UE (100) sends the RRC Reconfiguration Complete to the RRC layer of the gNB. At step 3, the L1/L2 and the RRC layer of the UE (100) performs the LTM (L1) measurements for candidate cells. Further, the L1/L2 and the RRC layer of the UE (100) skip L3 measurements on the LTM candidates.

FIG. 9 depicts the process of the L3 HO interacting with the LTM, according to embodiments as disclosed herein. At step 1, the RRC layer of the gNB sends the RRC Reconfiguration including the LTM configuration and the L3 measurement configuration to the RRC layer of the UE (100). At step 2, the RRC layer of the UE (100) sends the RRC Reconfiguration Complete to the RRC layer of the gNB. At step 3, the RRC layer of the UE (100) sends the RRC measurement report to the RRC layer of the gNB. At step 4, the RRC layer of the gNB sends the RRC Reconfiguration for handover to the RRC layer of the UE (100). At step 5, the L1/L2 layer of UE (100) cancels any triggered UL MAC CE for LTM measurement reports and any SR or BSR for LTM measurements reporting. Further, the L1/L2 layer of UE (100) stops the LTM measurements and evaluation.

FIG. 10 depicts the process of updating the security key while handling the LTM, according to embodiments as disclosed herein. At step 1, the RRC layer of the gNB sends the RRC Reconfiguration including the LTM configuration and the L3 measurement configuration to the RRC layer of the UE (100). At step 2, the RRC layer of the UE (100) sends RRC Reconfiguration Complete to the RRC layer of the gNB. At step 3, the L1/L2 and the RRC layer of the UE (100) clears LTM candidate cell configuration as per the embodiments.

FIG. 11 depicts the process of DAPS interacting with LTM, according to embodiments as disclosed herein.

At step 1, the RRC layer of the gNB sends the RRC Reconfiguration including the LTM configuration and the L3 measurement configuration to the RRC layer of the UE (100). At step 2, the RRC layer of the UE (100) sends the RRC Reconfiguration Complete to the RRC layer of the gNB. At step 3, the RRC layer of the UE (100) sends the RRC Measurement report to the RRC layer of the gNB. At step 4, the RRC layer of the gNB sends the RRC Reconfiguration for removing LTM configuration or part of LTM configuration to the RRC layer of the UE (100). At step 5, the RRC layer of the UE (100) sends the RRC Reconfiguration Complete to the RRC layer of the gNB. At step 6, the RRC layer of the gNB sends the RRC Reconfiguration including DAPS bearer and target RRC Reconfiguration without LTM configuration to the RRC layer of the UE (100). At step 7, the RRC layer of the UE (100) sends the RRC Reconfiguration Complete to the RRC layer of the gNB.

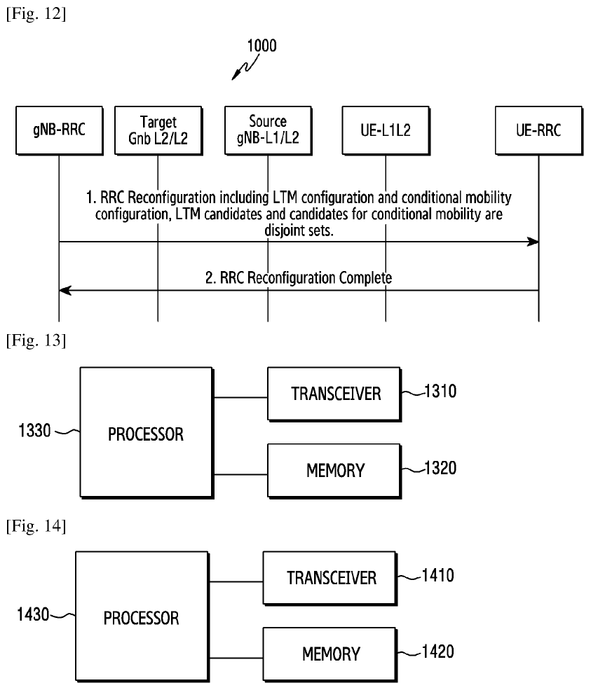

FIG. 12 depicts the process of performing conditional mobility configuration, according to embodiments as disclosed herein. At step 1, the RRC layer of the gNB sends the RRC Reconfiguration including LTM configuration and conditional mobility configuration. The LTM candidates and the candidates for conditional mobility are disjoint sets. At step 2, the RRC layer of the UE (100) sends RRC Reconfiguration Complete to the RRC layer of the gNB.

The various actions, acts, blocks, steps, or the like in the flow charts (400-700) may be performed in the order presented, in a different order or simultaneously. Further, in some embodiments, some of the actions, acts, blocks, steps, or the like may be omitted, added, modified, skipped, or the like without departing from the scope of the disclosure.

FIG. 13 illustrates a structure of a UE according to embodiments of the disclosure.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor. Furthermore, the UE of FIG. 13 corresponds to the UE of the FIG. 2.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a structure of a network entity according to embodiments as disclosed herein.

Referring to FIG. 14, the network entity includes a transceiver (1410), a memory (1420), and a processor (1430). The transceiver (1410), the memory (1420), and the processor (1430) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (1430), the transceiver (1410), and the memory (1420) may be implemented as a single chip. Also, the processor (1430) may include at least one processor.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (1410) collectively refers to a network entity receiver and a network entity transmitter, and may transmit/receive a signal to/from a base station or a UE. The signal transmitted or received to or from the base station or the UE may include control information and data. In this regard, the transceiver (1410) may include an RF transmitter for up-converting and amplifying a frequency of a transmitted signal, and an RF receiver for amplifying low-noise and down-converting a frequency of a received signal. However, this is only an example of the transceiver (1410) and components of the transceiver (1410) are not limited to the RF transmitter and the RF receiver.

The transceiver (1410) may receive and output, to the processor (1430), a signal through a wireless channel, and transmit a signal output from the processor (1430) through the wireless channel.

The memory (1420) may store a program and data required for operations of the network entity. Also, the memory (1420) may store control information or data included in a signal obtained by the network entity. The memory (1420) may be a storage medium, such as a ROM, a RAM, a hard disk, a CD-ROM, and a DVD, or a combination of storage media.

The processor (1430) may control a series of processes such that the network entity operates as described above. For example, the transceiver (1410) may receive a data signal including a control signal, and the processor (1430) may determine a result of receiving the data signal.

The processor disclosed herein may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In various embodiments, a method for handling a lower layer triggered mobility (LTM) in a wireless network (1000), comprising: receiving, by a User Equipment (UE) (100), a radio resource control (RRC) Reconfiguration comprising a LTM configuration having at least one of: a LTM candidate cell configuration, a LTM measurement configuration, and a LTM reference configuration from a network entity (200); sending, by the UE (100), a RRC reconfiguration complete to the network entity (200) based on the RRC Reconfiguration, on completing the RRC reconfiguration successfully; and reusing, by the UE (100), one of: a Layer 3 (L3) measurement result, and a part of the L3 measurement result for a LTM measurement, when the UE (100) is measuring the same reference signal for the L3 measurement result and the LTM measurement.

Preferably, the network entity (200) provides the LTM configuration comprising at least one of: the LTM candidate cell configuration, the LTM reference configuration, and the LTM measurement configuration in the RRC Reconfiguration when an Access Stratum (AS) security has been activated.

Preferably, the network entity (200) provides the LTM configuration comprising at least one of: the LTM candidate cell configuration, the LTM reference configuration, and the LTM measurement configuration in the RRC Reconfiguration when a Signaling Radio Bearer 2 (SRB2) with at least one of one Data Radio Bearer (DRB) is setup and not suspended or when one of: a multicast multi-cast radio bearer (MRB), and the SRB2 are setup and not suspended.

Preferably, the network entity (200) provides the LTM configuration for a Secondary Cell Group (SCG) in a New Radio Dual Connectivity (NR-DC) in the RRC Reconfiguration in a SRB3.

Preferably, the reference signal corresponds to same serving cell or same neighbor cell.

In various embodiments, a method for handling a lower layer triggered mobility in a wireless network (1000), comprising: receiving, by a UE (100), a RRCReconfiguration comprising information for releasing a LTM configuration; and releasing, by the UE (100), the LTM configuration, based on the received RRC Reconfiguration.

In various embodiments, a method for handling a lower layer triggered mobility, comprising: receiving, by a first network entity, a Dual Active Protocol Stack (DAPS) handover command in the first network entity from a second network entity; sending, by the first network entity, the DAPS handover command to the UE (100); and releasing, by the first network entity, a LTM configuration prior to sending the DAPS handover command to the UE (100).

Preferably, the method further comprises: skipping, by a second network entity, configuring LTM configuration until the DAPS handover is completed.

In various embodiments, a method for handling a lower layer triggered mobility in a wireless network (1000), comprising: sending, by a network entity (200), a radio resource control (RRC) Reconfiguration comprising a LTM configuration having at least one of: a LTM candidate cell configuration, a LTM measurement configuration, and a LTM reference configuration to a User Equipment (UE) (100); and receiving, by the network entity (200), a RRC reconfiguration complete from the UE (100) based on the RRC Reconfiguration.

Preferably, the network entity (200) provides the LTM configuration comprising at least one of: the LTM candidate cell configuration, the LTM reference configuration, and the LTM measurement configuration in the RRC Reconfiguration when an Access Stratum (AS) security has been activated.

Preferably, the network entity (200) provides the LTM configuration comprising at least one of: the LTM candidate cell configuration, the LTM reference configuration, and the LTM measurement configuration in the RRC Reconfiguration when a Signaling Radio Bearer 2 (SRB2) with at least one of one Data Radio Bearer (DRB) is setup and not suspended or when one of: a multicast multi-cast radio bearer (MRB), and the SRB2 are setup and not suspended.

Preferably, the network entity (200) provides the LTM configuration for a SCG in a NR-DC in the RRC Reconfiguration included in a SRB3 when RRC Reconfiguration is not send via a DLInformationTransferMRDC.

In various embodiments, a UE (100), comprising: a processor (110); a memory (130); and a LTM controller (140), coupled with the processor (110) and the memory (130), configured to: receive a radio resource control (RRC) Reconfiguration comprising a LTM configuration having at least one of: a LTM candidate cell configuration, a LTM measurement configuration, and a LTM reference configuration from a network entity (200); send a RRC reconfiguration complete to the network entity (200) based on the RRC Reconfiguration, on completing the RRC reconfiguration successfully; and reuse one of: a L3 measurement result and a part of the L3 measurement result for the LTM measurement when the UE (100) is measuring the same reference signal for the L3 measurement result and the LTM measurement.

In various embodiments, a UE (100), comprising: a processor (110); a memory (130); and a LTM controller (140), coupled with the processor (110) and the memory (130), configured to: receive a RRC Reconfiguration comprising information for releasing a LTM configuration; and release the LTM configuration based on the RRC Reconfiguration.

In various embodiments, A network entity (200), comprising: a processor (210); a memory (230); and a LTM controller (240), coupled with the processor (210) and the memory (230), configured to: receive a Dual Active Protocol Stack (DAPS) handover command in the first network entity from a second network entity; send the DAPS handover command to the UE (100); and release a LTM configuration prior to triggering the DAPS handover command to the UE (100).

In various embodiments, a network entity (200), comprising: a processor (210); a memory (230); and a LTM controller (240), coupled with the processor (210) and the memory (230), configured to: send a radio resource control (RRC) Reconfiguration comprising a LTM configuration having at least one of: a LTM candidate cell configuration, a LTM measurement configuration, and a LTM reference configuration to a User Equipment (UE) (100); and receive a RRC reconfiguration complete from the UE (100) based on the RRC Reconfiguration.

The embodiments disclosed herein can be implemented through at least one software program running on at least one hardware device and performing network management functions to control the elements. The elements can be at least one of a hardware device, or a combination of hardware device and software module.

Embodiments herein have been explained using 5G and associated modules (gNB, NR, UE,); however, it may be obvious to a person of ordinary skill in the art that embodiments herein can be extended to any network/technology (6G, and so on) and associated components (i.e., gNB can be any network node, and the UE can be of any technology/network and so on).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1.-15. (canceled)

16. A method performed by a user equipment (UE) in a wireless communication system, the method comprising:
receiving, from a base station (BS), a first radio resource control (RRC) reconfiguration message including a layer1/layer2 (L1/L2) triggered mobility (LTM) configuration;
receiving, from the BS, a second RRC reconfiguration message for requesting a handover; and
canceling a triggered L1 measurement report based on the second RRC reconfiguration message.

17. The method of claim 16, wherein the canceling of the triggered L1 measurement report includes canceling a scheduling request triggered for the triggered L1 measurement report.

18. The method of claim 16, wherein, in case that the handover is a dual active protocol stack (DAPS) handover, the method further comprises:
receiving, from the BS, a third RRC reconfiguration message including information for releasing the LTM configuration before the receiving of the second RRC reconfiguration message, and
releasing the LTM configuration based on the information.

19. The method of claim 16,
wherein the LTM configuration is received via a signaling radio bearer 3 (SRB3), in case that an access stratum (AS) security is activated, and a signaling radio bearer 2 (SRB2) and a data radio bearer (DRB) are setup and not suspended, and
wherein the LTM configuration is not included within conditionalReconfiguration information element (IE) of the first RRC reconfiguration message.

20. A user equipment (UE) in a wireless communication system, the UE comprising:
a transceiver; and
a controller coupled with the transceiver and configured to:
receive, from a base station (BS), a first radio resource control (RRC) reconfiguration message including a layer1/layer2 (L1/L2) triggered mobility (LTM) configuration;
receive, from the BS, a second RRC reconfiguration message for requesting a handover; and
cancel a triggered L1 measurement report based on the second RRC reconfiguration message.

21. The UE of claim 20, wherein the canceling of the triggered L1 measurement report includes canceling a scheduling request triggered for the triggered L1 measurement report.

22. The UE of claim 20, wherein, in case that the handover is a dual active protocol stack (DAPS) handover, the controller is further configured to:
receive a third RRC reconfiguration message including information for releasing the LTM configuration before the receiving of the second RRC reconfiguration message, and
release the LTM configuration based on the information.

23. The UE of claim 20,
wherein the LTM configuration is received via a signaling radio bearer 3 (SRB3), in case that an access stratum (AS) security is activated, and a signaling radio bearer 2 (SRB2) and a data radio bearer (DRB) are setup and not suspended, and
wherein the LTM configuration is not included within conditionalReconfiguration information element (IE) of the first RRC reconfiguration message.

24. A method performed by a base station (BS) in a wireless communication system, the method comprising:
transmitting, to a user equipment (UE), a first radio resource control (RRC) reconfiguration message including a layer1/layer2 (L1/L2) triggered mobility (LTM) configuration; and
transmitting, to the UE, a second RRC reconfiguration message for requesting a handover,
wherein a triggered L1 measurement report is canceled based on the second RRC reconfiguration message.

25. The method of claim 24,
wherein the LTM configuration is transmitted via a signaling radio bearer 3 (SRB3), in case that an access stratum (AS) security is activated, and a signaling radio bearer 2 (SRB2) and a data radio bearer (DRB) are setup and not suspended.

26. The method of claim 24, wherein, in case that the handover is a dual active protocol stack (DAPS) handover, the method further comprises:
transmitting, to the UE, a third RRC reconfiguration message including information for releasing the LTM configuration before the transmitting of the second RRC reconfiguration message.

27. The method of claim 24,
wherein the LTM configuration is not included within conditionalReconfiguration information element (IE) of the first RRC reconfiguration message.

28. A base station (BS) in a wireless communication system, the BS comprising:
a transceiver; and
a controller coupled with the transceiver and configured to:
transmit, to a user equipment (UE), a first radio resource control (RRC) reconfiguration message including a layer1/layer2 (L1/L2) triggered mobility (LTM) configuration; and
transmit, to the UE, a second RRC reconfiguration message for requesting a handover,
wherein a triggered L1 measurement report is canceled based on the second RRC reconfiguration message.

29. The BS of claim 28, wherein, in case that the handover is a dual active protocol stack (DAPS) handover, the controller further configured to transmit a third RRC reconfiguration message including information for releasing the LTM configuration before the transmitting of the second RRC reconfiguration message.

30. The BS of claim 28,
wherein the LTM configuration is transmitted via a signaling radio bearer 3 (SRB3), in case that an access stratum (AS) security is activated, and a signaling radio bearer 2 (SRB2) and a data radio bearer (DRB) are setup and not suspended, and
wherein the LTM configuration is not included within conditionalReconfiguration information element (IE) of the first RRC reconfiguration message.
